(19) United States
(12) Patent Application Publication
(10) Pub. No.: US 2011/0317868 A1
(43) Pub. Date: Dec. 29, 2011

(54) ELECTROACOUSTIC TRANSDUCER

(75) Inventor: Chisato Tsujii, Osaka (JP)

(73) Assignee: SANYO ELECTRIC CO., LTD., Osaka (JP)

(21) Appl. No.: 13/168,591

(22) Filed: Jun. 24, 2011

(30) Foreign Application Priority Data
Jun. 25, 2010 (JP) 2010-144945

(51) Int. Cl. H04R 1/00

(52) U.S. Cl. 381/400

(57) ABSTRACT

A diaphragm has a back plane which has a voice coil attached thereto, and a front plane which is located on the side opposite to the back plane. The diaphragm also includes a center portion, a boundary portion which surrounds the center portion and has the voice coil attached thereto, an outer circumferential portion which surrounds the boundary portion, and an edge which surrounds the outer circumferential portion. A frame has a support portion which supports the back plane of the diaphragm. The outer circumferential portion has a convex shape which protrudes in the thickness direction extending from the front plane to the hack plane with respect to the edge.

This nonprovisional application is based on Japanese Patent Application No. 2010-144945 filed on Jun. 25, 2010, with the Japan Patent Office, the entire contents of which are hereby incorporated by reference.

### BACKGROUND OF THE INVENTION

1. Field of the Invention

The present invention relates to an electroacoustic transducer, and particularly to an electroacoustic transducer including a diaphragm that has a voice coil attached thereto.

2. Description of the Related Art

Electrical devices such as a mobile phone and a digital still camera have an electroacoustic transducer mounted therein. The electroacoustic transducer serves as a device transducing an electrical signal to an acoustic signal and vice versa, which is, for example, a speaker, a receiver or a microphone. The electroacoustic transducer also has a diaphragm. The diaphragm that is widely used includes a center portion, a boundary portion surrounding the center portion and having a voice coil attached thereto, an outer circumferential portion surrounding the boundary portion, and an edge surrounding the boundary portion. In the speaker, in order to vibrate the diaphragm, the boundary portion is displaced by the voice coil in the state where the edge is secured. This causes a change in the distance between the edge and the boundary portion. Accordingly, the portion of the diaphragm between the edge and the boundary portion, that is, the outer circumferential portion, has a convex shape in the thickness direction so as to allow this portion to accommodate the change in the distance. By slightly changing the protruding degree of this convex shape, the above-described change in the distance can be accommodated.

In recent years, there is a need for improvement in waterproof performance of the above-described electrical devices. In response to this need, for example, Japanese Patent Laying-Open No. 2004-159181 (FIGS. 2 and 5) discloses a waterproof speaker including a diaphragm for preventing water from entering from outside.

In the case where the diaphragm prevents water from entering from outside, the hydraulic pressure applied to the diaphragm from outside may cause deformation of the above-described outer circumferential portion of the diaphragm. When the outer circumferential portion is greatly deformed, sound quality may deteriorate. Furthermore, a particularly great deformation in this portion may prevent the diaphragm from returning to its original shape even if the hydraulic pressure is removed. In this case, the deterioration of the sound quality resulting from deformation of the diaphragm is rendered permanent.

### SUMMARY OF THE INVENTION

The present invention has been made in light of the above-described problems. An object of the present invention is to provide an electroacoustic transducer capable of suppressing deterioration of the sound quality caused by deformation of a diaphragm which results from the pressure such as hydraulic pressure applied from outside.

The electroacoustic transducer according to the present invention includes a voice coil, a diaphragm and a frame. The diaphragm has a back plane which has the voice coil attached thereto and a front plane on a side opposite to the hack plane. The diaphragm includes a center portion, a boundary portion which surrounds the center portion and has the voice coil attached thereto, an outer circumferential portion which surrounds the boundary portion, and an edge which surrounds the outer circumferential portion. The frame has a support portion which supports the hack plane of the diaphragm. The outer circumferential portion has a convex shape which protrudes, with respect to the edge, in a thickness direction from the front plane to the back plane.

According to the present invention, the convex shape provided in the outer circumferential portion protrudes in the thickness direction extending from the front plane to the back plane, that is, in the direction in which a hydraulic pressure is applied (which will be hereinafter referred to as a hydraulic-pressure applying direction). Accordingly, even if a hydraulic pressure is applied to the diaphragm, the diaphragm does not undergo deformation in such a manner that the protruding direction of the outer circumferential portion is reversed from the opposite direction of the hydraulic-pressure applying direction to the hydraulic-pressure applying direction. Therefore, the diaphragm can be prevented from being greatly deformed in such a manner that the above-described protruding direction is reversed.

Furthermore, the above-described convex shape of the outer circumferential portion protrudes in the hydraulic-pressure applying direction with respect to the edge. In other words, the convex-shaped portion is located downstream in the hydraulic-pressure applying direction with respect to the edge. More specifically, the edge is located, with respect to the convex-shaped portion, in the direction opposite to the hydraulic-pressure applying direction. Consequently, when a hydraulic pressure is applied, the edge is caused to pull the convex-shaped portion in the direction opposite to the hydraulic-pressure applying direction. Therefore, the diaphragm can be prevented from being deformed in such a manner that the convex-shaped portion is displaced in the hydraulic-pressure applying direction while maintaining the protruding direction of the convex-shaped portion.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view schematically showing the configuration of a speaker as an electroacoustic transducer in the first embodiment of the present invention.

FIG. 2 is a schematic front view of FIG. 1.

FIG. 3 is a schematic bottom view of FIG. 1.

FIG. 4 is a schematic cross-sectional view taken along a line IV-IV in FIG. 1.

FIG. 5 is a schematic cross-sectional view taken along a line V-V in FIG. 1.

FIG. 6 is a cross-sectional view showing the configuration of a speaker of a comparative example.

FIGS. 7 and 8 are cross-sectional views each schematically showing the configuration of the speaker as an electroacoustic transducer in the second embodiment of the present invention, and also show cross-sectional views corresponding to the cross-sectional positions in FIGS. 4 and 5, respectively.

FIG. 9 is a cross-sectional view schematically showing the configuration of a speaker as an electroacoustic transducer in the third embodiment of the present invention, and also shows a cross-sectional view corresponding to the cross-sectional position in FIG. 4.

FIG. 10 is a cross-sectional view schematically showing the configuration of a speaker as an electroacoustic transducer in the fourth embodiment, and also shows a cross-sectional view corresponding to the cross-sectional position in FIG. 5.

### DESCRIPTION OF THE PREFERRED EMBODIMENTS

The embodiments of the present invention will be hereinafter described with reference to the drawings.

### First Embodiment

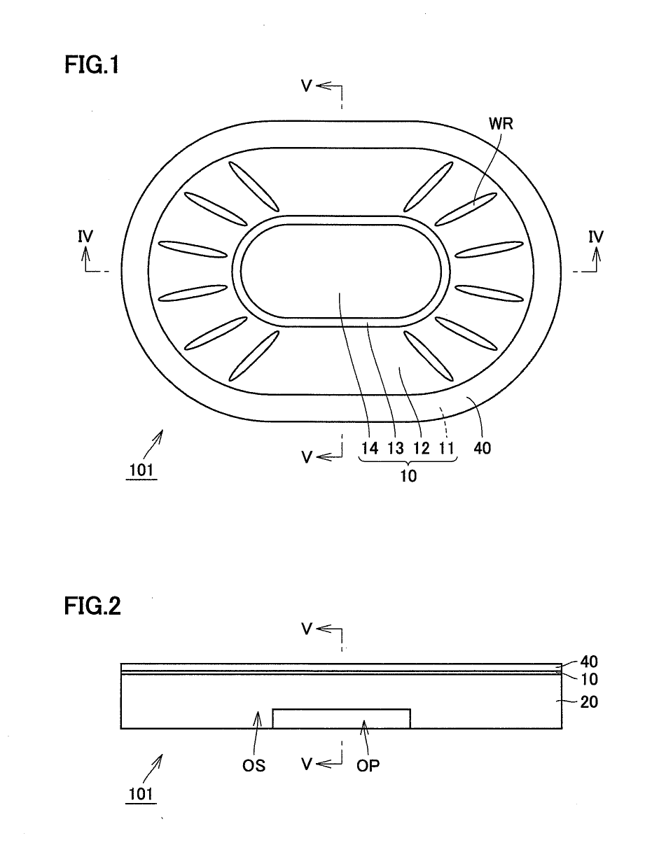

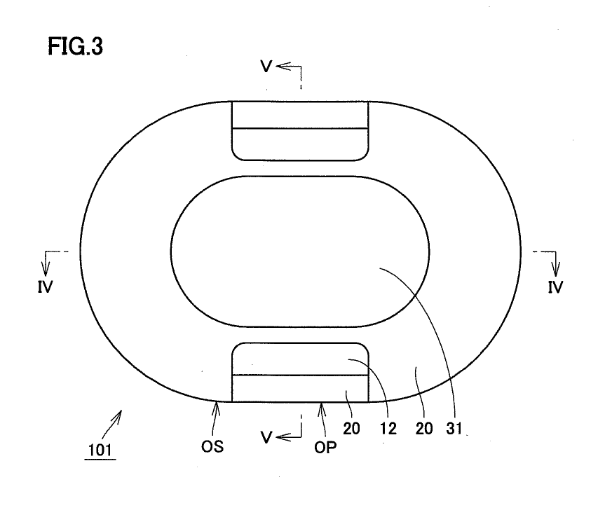

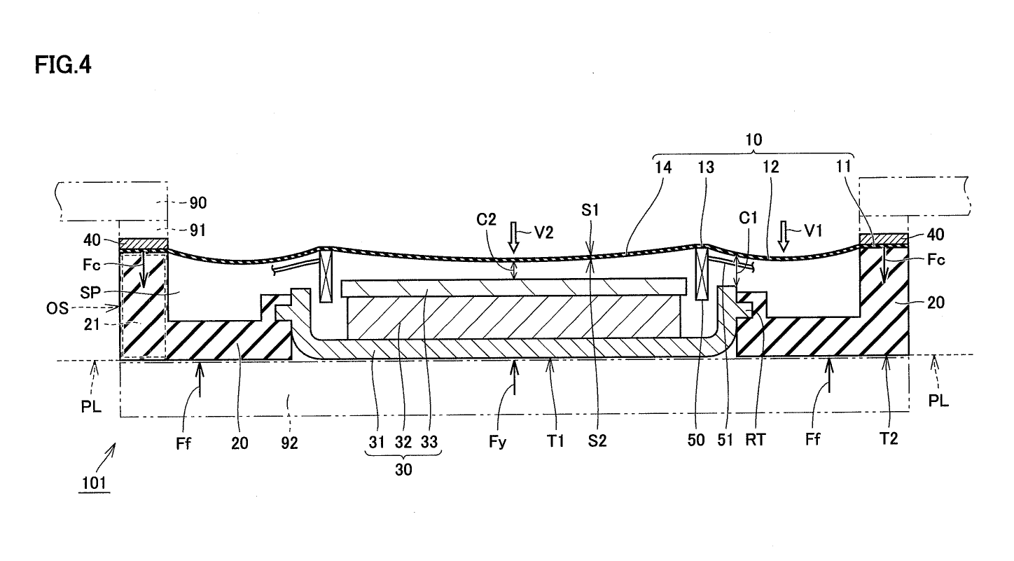

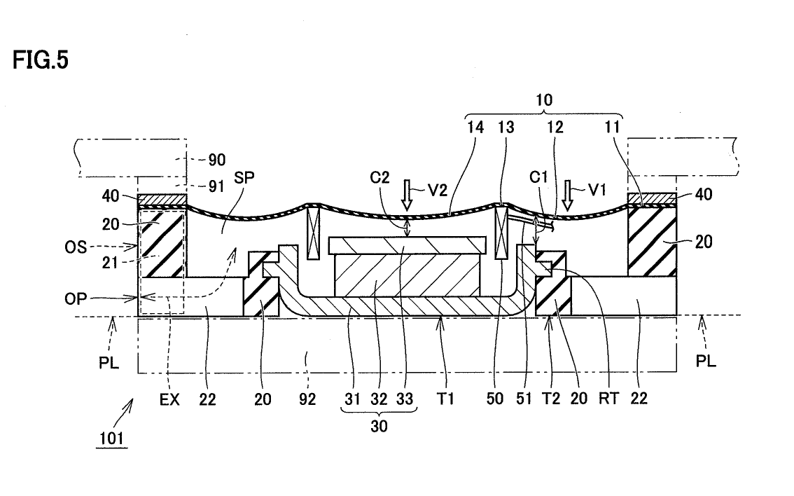

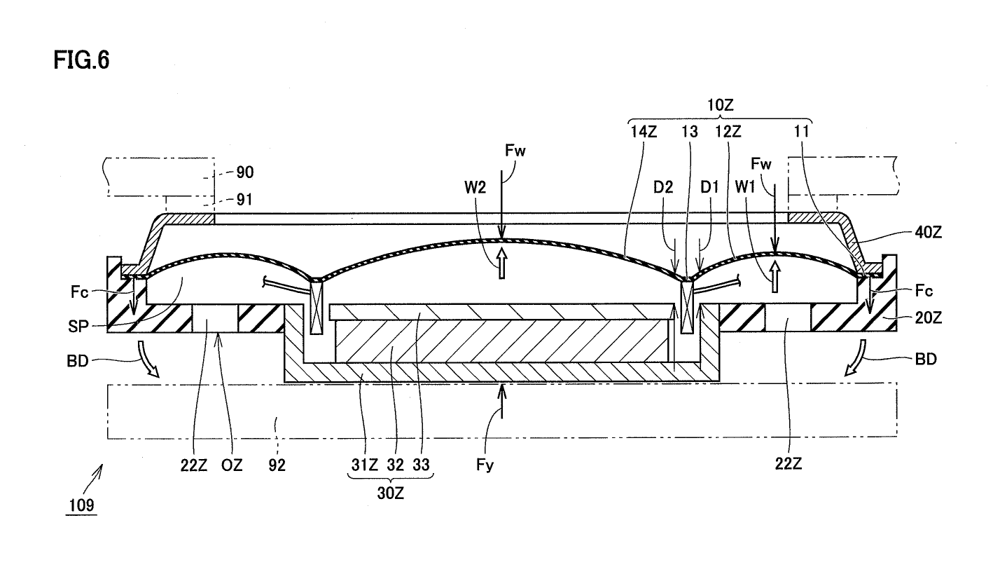

Referring to FIGS. 1 to 5, an electroacoustic transducer according to the present embodiment serves as a speaker 101. It is to be noted that each figure shows the state where no hydraulic pressure is applied to speaker 101. Furthermore, in addition to speaker 101, FIGS. 4 and 5 each show a casing 90, a double-faced tape 91 and an attachment member 92 by an alternate long and two short dashed line. Casing 90 has an opening that is to be closed by speaker 101. Casing 90 and speaker 101 are secured to each other by double-faced tape 91. Casing 90 used as a casing for electrical devices is equipped with speaker 101 so as to close the opening provided in casing 90. Attachment member 92 presses the backside of speaker 101 (underside in FIGS. 4 and 5), which causes speaker 101 to be pressed against casing 90. Consequently, water leakage between speaker 101 and casing 90 can be prevented. Attachment member 92 may include an elastic member, in which case speaker 101 is pressed against casing 90 by the elasticity of attachment member 92.

Speaker 101 includes a voice coil 50, a lead wire 51, a diaphragm 10, a frame 20, a magnetic circuit portion 30, and a cover 40.

Diaphragm 10 has a back plane S2 to which voice coil 50 is attached, and a front plane S1 on the side opposite to back plane S2. Furthermore, diaphragm 10 includes a center portion 14, a boundary portion 13 surrounding center portion 14 and having voice coil 50 attached thereto, an outer circumferential portion 12 surrounding boundary portion 13, and an edge 11 surrounding outer circumferential portion 12. Edge 11 is secured to frame 20, so that the portions of diaphragm 10 other than edge 11, that is, outer circumferential portion 12, boundary portion 13 and center portion 14, can be vibratably held. Furthermore, the voice coil secured to boundary portion 13 can drive diaphragm 10 so as to vibrate diaphragm 10. Diaphragm 10 is made of the material that is impermeable to water. Such a material may include a synthetic resin, for example. Used as a synthetic resin is, for example, PET (polyethylene terephthalate), PEN (polyethylene naphthalate), PEI (polyetherimide), or the like.

As shown by an arrow V1 (FIGS. 4 and 5), outer circumferential portion 12 has a convex shape protruding downward (in the thickness direction from front plane S1 to hack plane S2) with respect to edge 11. In other words, outer circumferential portion 12 has a convex shape that protrudes downward with respect to edge 11. Preferably, this entire convex shape is located lower than edge 11. More preferably, the upper limit of the height of outer circumferential portion 12 (the position to be limited in the upward direction in FIGS. 4 and 5) corresponds to the height of edge 11. It is to be noted that a ridge and a groove WR (shown only in FIG. 1) may be formed in outer circumferential portion 12 for the purpose of improving sound quality.

As shown by an arrow V2 (FIGS. 4 and 5), center portion 14 has a convex shape protruding downward (in the thickness direction from front plane S1 to back plane S2) with respect to boundary portion 13. In other words, center portion 14 has a convex shape that protrudes downward with respect to boundary portion 13. Preferably, this entire convex shape is located lower than boundary portion 13. More preferably, the upper limit of the height of center portion 12 (the position to be limited in the upward direction in FIGS. 4 and 5) corresponds to the height of boundary portion 13.

Frame 20 has a support portion 21 supporting back plane S2 of edge 11 of diaphragm 10. Support portion 21 extends from attachment member 92 toward back plane S2 of edge 11 of diaphragm 10 so as to cause the force from attachment member 92 to be transmitted to diaphragm 10. Frame 20 is made, for example, of synthetic resin. Furthermore, frame 20 has a bottom plane T2 (the second bottom plane).

Frame 20 is also located across space SP from outer circumferential portion 12 of diaphragm 10 in the thickness direction. Furthermore, frame 20 has a communicating path 22 (FIG. 5) that allows communication between space SP and the space external to frame 20. Preferably, communicating path 22 has an opening OP in an outer side plane OS of support portion 21. Opening OP is located at a distance away from the upper plane of support portion 21 (the plane which supports edge 11) and disposed on the flat plane including bottom plane T2 (a flat plane PL which will be described later).

Magnetic circuit portion 30 serves to apply a magnetic field to voice coil 50 and includes a yoke 31, a magnet 32 and a top pole 33, for example.

Yoke 31 of magnetic circuit portion 30 has a bottom plane T1 (the first bottom plane). Bottom plane T1 is surrounded by bottom plane T2 of frame 20. Bottom planes T1 and T2 are located on flat plane PL. The plane of attachment member 92 is also located on flat plane PL. Furthermore, yoke 31 may have a protrusion RT located on the plane of frame 20 on the side opposite to bottom plane T2.

Magnet 32 of magnetic circuit portion 30 is disposed on the upper plane of yoke 31 (the plane on the side opposite to bottom plane T1). Top pole 33 of magnetic circuit portion 30 is disposed on magnet 32 and is made of ferromagnetic material. Preferably, a clearance C1 between magnetic circuit portion 30 and outer circumferential portion 12 is greater in the thickness direction than a clearance C2 between magnetic circuit portion 30 and center portion 14.

Cover 40 is disposed on support portion 21 of frame 20 with edge 11 of diaphragm 10 interposed therebetween. Cover 40 is made, for example, of a metal plate.

Voice coil 50 receives Lorentz force by the interaction between the magnetic field produced by magnetic circuit portion 30 and the current supplied through lead wire 51. This allows boundary portion 13 of diaphragm 10 to be driven in the thickness direction. Lead wire 51 extends from voice coil 50 through between outer circumferential portion 12 of diaphragm 10 and yoke 31 then to the outside of frame 20. In order to cause lead wire 51 to extend in this way, a groove (not shown) may be provided on the plane of frame 20 facing edge 11 of diaphragm 10.

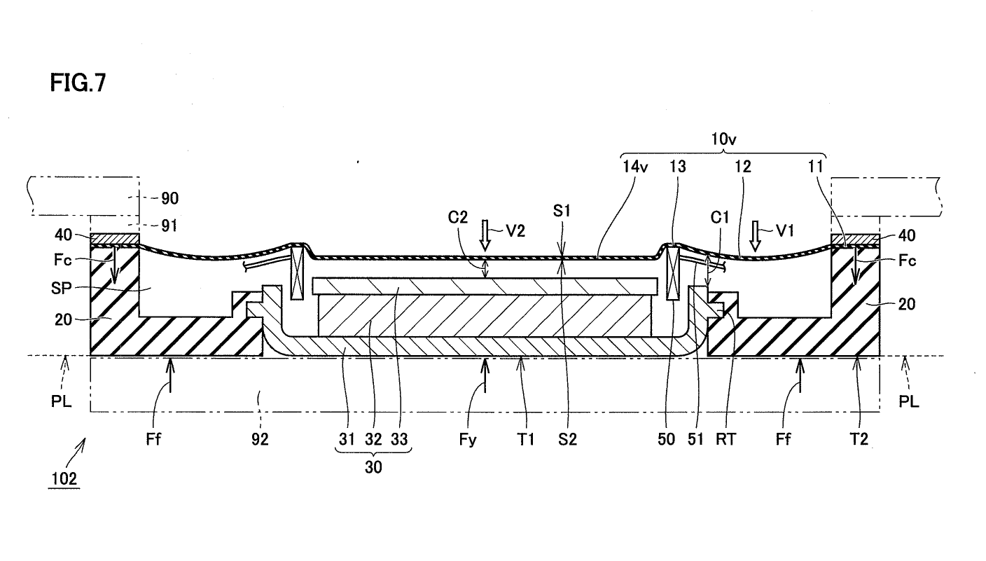

Then, a speaker 109 in a comparative example (FIG. 6) will be hereinafter described.

An outer circumferential portion 12Z of a diaphragm 10Z has a convex shape protruding, as indicated by an arrow W1 (FIG. 6), in the direction opposite to the direction indicated by arrow V1 (FIG. 4), that is, in the direction opposite to the hydraulic-pressure applying direction. Therefore, when a hydraulic pressure Fw is applied to diaphragm 10Z from outside, diaphragm 10Z is readily deformed in such a manner that the protruding direction of outer circumferential portion 12Z is reversed from the opposite direction of the hydraulic-pressure applying direction (the upward direction in the figure) to the hydraulic-pressure applying direction (the downward direction in the figure). In other words, diaphragm 10Z is readily greatly deformed in such a manner that the protruding direction of the convex shape is reversed.

Furthermore, a center portion 14Z of diaphragm 10Z has a convex shape protruding, as indicated by an arrow W2 (FIG. 6), in the direction opposite to the direction indicated by arrow V2 (FIG. 4), that is, in the direction opposite to the hydraulic-pressure applying direction. Therefore, when hydraulic pressure Fw is applied to diaphragm 10Z from outside, diaphragm 10Z is readily deformed in such a manner that the protruding direction of center portion 147 is reversed from the opposite direction of the hydraulic-pressure applying direction (the upward direction in the figure) to the hydraulic-pressure applying direction (the downward direction in the figure). In other words, diaphragm 10Z is readily greatly deformed in such a manner that the protruding direction of the convex shape is reversed.

Furthermore, since the bottom plane of a yoke 31Z of a magnetic circuit portion 30Z is located lower than the bottom plane of a frame 20Z, the upper plane of attachment member 92 does not press frame 20Z but presses only yoke 31Z. This causes only yoke 31Z to be strongly pressed by a force Fy. In addition, a force Fc acts on frame 20Z against this force Fy. In other words, in speaker 109, upward force Fy acts on the center portion and downward force Fc acts on the edge. Consequently, deformation occurs in such a manner that speaker 109 is distorted as indicated by an arrow BD. This deformation may cause water leakage resulting from the deterioration of the close contact performance between speaker 109 and casing 90.

Furthermore, a clearance D1 between magnetic circuit portion 30Z and outer circumferential portion 12Z is equal in the thickness direction to a clearance D2 between magnetic circuit portion 30Z and center portion 14Z. Consequently, when diaphragm 10Z is displaced by the hydraulic pressure in the thickness direction, that is, in the hydraulic-pressure applying direction, center portion 14Z and outer circumferential portion 12Z are simultaneously brought into contact with magnetic circuit portion 30Z. In this case, lead wire 51 is sandwiched between outer circumferential portion 12Z and magnetic circuit portion 30Z, which may cause damage to lead wire 51.

Furthermore, a communicating path 22Z has an opening OZ in the bottom plane of frame 20Z. In order to prevent closure of opening OZ, the upper plane of attachment member 92 should be disposed at a distance away from the bottom plane of frame 20Z. Consequently, the bottom plane of frame 20Z cannot be pressed by the upper plane of attachment member 92, but only yoke 31Z can be pressed thereby. This facilitates occurrence the above-described distortion of speaker 109.

Furthermore, outer circumferential portion 12Z protrudes in the upward direction. Accordingly, a cover 40Z extends upward from edge 11 in order to ensure the space above edge 11. This leads to an increase in the volume between the height of edge 11 and the height of casing 90, thereby causing the volume of speaker 109 to be increased correspondingly. This makes it difficult to decrease the size of the electrical equipment on which speaker 109 is mounted.

As described above, speaker 109 in the comparative example presents various problems.

In contrast, according to the present embodiment, the convex shape provided in outer circumferential portion 12 (FIGS. 4 and 5: arrow V1) protrudes in the thickness direction from front plane S1 toward back plane S2 (the downward direction in the figure), that is, in the hydraulic-pressure applying direction. Therefore, even if a hydraulic pressure is applied to diaphragm 10, diaphragm 10 does not undergo deformation in such a manner that the protruding direction of outer circumferential portion 12 is reversed from the opposite direction of the hydraulic-pressure applying direction to the hydraulic-pressure applying direction. Therefore, diaphragm 10 can be prevented from being greatly deformed in such a manner that the protruding direction is reversed.

Furthermore, this convex shape (FIGS. 4 and 5: arrow V1) protrudes in the hydraulic-pressure applying direction with respect to edge 11. In other words, the convex-shaped portion is located downstream in the hydraulic-pressure applying direction with respect to edge 11. More specifically, edge 11 is located, with respect to the convex-shaped portion, in the direction opposite to the hydraulic-pressure applying direction. Accordingly, when a hydraulic pressure is applied, edge 11 is caused to pull the convex-shaped portion in the direction opposite to the hydraulic-pressure applying direction. Consequently, diaphragm 10 can be prevented from being deformed in such a manner that the convex-shaped portion is displaced in the hydraulic-pressure applying direction while maintaining the protruding direction of the convex-shaped portion.

Furthermore, the convex shape provided in center portion 14 (FIGS. 4 and 5: arrow V2) protrudes in the thickness direction from front plane S1 toward back plane S2 (the downward direction in the figure), that is, in the hydraulic-pressure applying direction. Therefore, even if a hydraulic pressure is applied to diaphragm 10, diaphragm 10 is not deformed in such a manner that the protruding direction of center portion 14 is reversed from the opposite direction of the hydraulic-pressure applying direction to the hydraulic-pressure applying direction. Consequently, diaphragm 10 can be prevented from being greatly deformed in such a manner that the protruding direction is reversed.

Furthermore, the above-described convex shape of center portion 14 protrudes in the hydraulic-pressure applying direction with respect to boundary portion 13. In other words, the convex-shaped portion is located downstream in the hydraulic-pressure applying direction with respect to boundary portion 13. More specifically, boundary portion 13 is located, with respect to the convex-shaped portion, in the direction opposite to the hydraulic-pressure applying direction. Accordingly, when a hydraulic pressure is applied, boundary portion 13 is caused to pull the convex-shaped portion in the direction opposite to the hydraulic-pressure applying direction. Consequently, diaphragm 10 can be prevented from being deformed in such a manner that the convex-shaped portion is displaced in the hydraulic-pressure applying direction while maintaining the protruding direction of the convex-shaped portion.

Furthermore, since both of bottom planes T1 and T2 are located on flat plane PL, not only bottom plane T1 of yoke 31 but also bottom plane T2 of frame 20 can be pressed by a force Ff (FIG. 4). Accordingly, deformation of speaker 101 (FIG. 6: arrow BD) is prevented as compared with the case where only yoke 31 is strongly pressed by force Fy (FIG. 4). Consequently, water leakage resulting from this deformation can be prevented. Furthermore, when protrusion RT (FIG. 4) is provided, the lower plane of the protrusion is prevented from being separated from frame 20.

Preferably, as shown in FIGS. 4 and 5, clearance C1 between magnetic circuit portion 30 and outer circumferential portion 12 is greater in the thickness direction than clearance C2 between magnetic circuit portion 30 and center portion 14. Accordingly, when diaphragm 10 is displaced by the hydraulic pressure in the thickness direction, that is, in the hydraulic-pressure applying direction, center portion 14 is brought into contact with magnetic circuit portion 30 prior to outer circumferential portion 12. Since this contact allows center portion 14 of diaphragm 10 to be supported by magnetic circuit portion 30, further deformation of diaphragm 10 can be suppressed. Consequently, contact between outer circumferential portion 12 and magnetic circuit portion 30 is prevented, which allows prevention of damage to lead wire 51 that is caused by lead wire 51 being sandwiched between outer circumferential portion 12 and magnetic circuit portion 30.

Preferably, as shown in FIG. 5, communicating path 22 has opening OP in outer side plane OS of support portion 21. Accordingly, opening OP is provided not in bottom plane T2 of frame 20 but in outer side plane OS thereof. Therefore, even when attachment member 92 is disposed on bottom plane T2 of frame 20, an airflow EX through communicating path 22 caused by vibration of diaphragm 10 is not obstructed.

### Second Embodiment

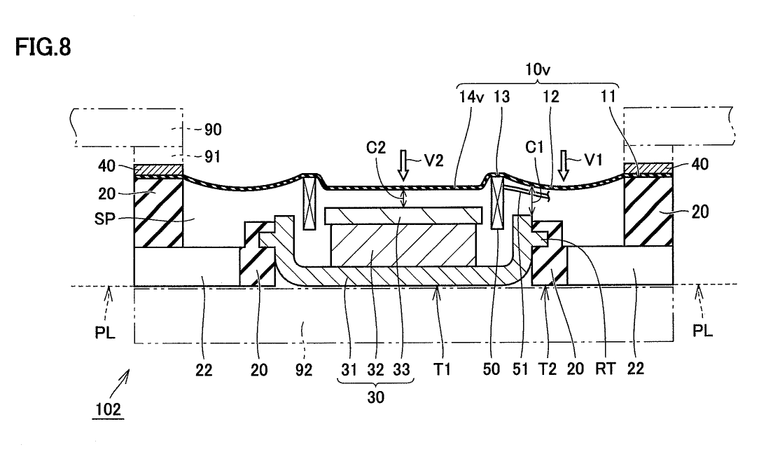

Referring to FIGS. 7 and 8, a speaker 102 as an electroacoustic transducer of the present embodiment has a diaphragm 10v in place of diaphragm 10 (FIGS. 4 and 5). Diaphragm 10v has a center portion 14v in place of center portion 14 (FIGS. 4 and 5). Center portion 14v has a flat portion as a portion most protruding in the thickness direction (the downward direction in the figure). Accordingly, when center portion 14v is displaced in the thickness direction, that is, in the hydraulic-pressure applying direction and brought into contact with the structure such as magnetic circuit portion 30, this contact area of center portion 14v can be increased in size. Consequently, deformation of center portion 14v resulting from this contact can be suppressed.

In addition, since the configurations other than those described above are almost the same as the configuration of the above-described first embodiment, the same or corresponding components are designated by the same reference characters, and description thereof will not be repeated.

### Third Embodiment

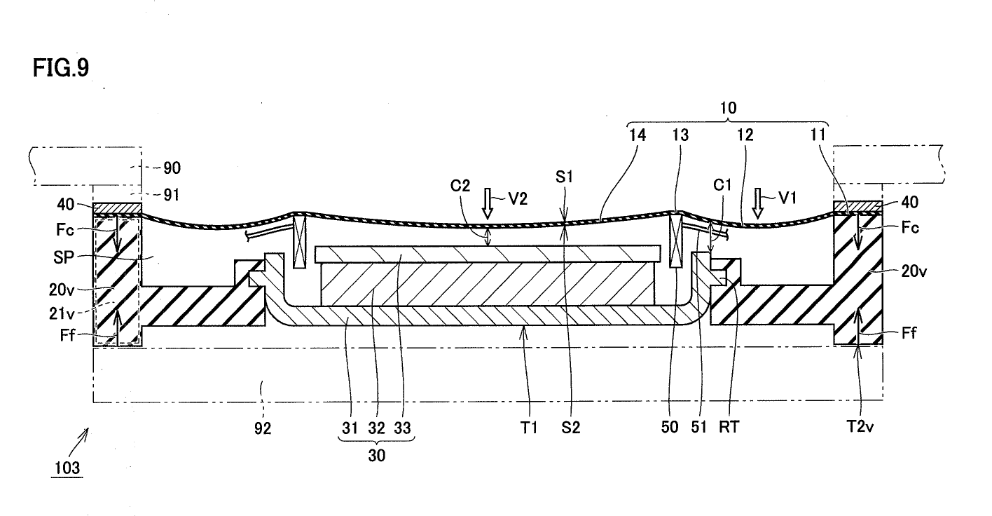

Referring to FIG. 9, a speaker 103 as an electroacoustic transducer of the present embodiment has a frame 20v in place of frame 20 (FIGS. 4 and 5). A bottom plane T2v (the second bottom plane) of frame 20v protrudes in the thickness direction (the downward direction in the figure) with respect to bottom plane T1 of yoke 31. Accordingly, attachment member 92 can readily press bottom plane T2 of frame 20v without being obstructed by bottom plane T1 of yoke 31. Consequently, it becomes possible to prevent deformation of speaker 101 (similar to the deformation shown by arrow BD in FIG. 6) that is caused by strongly pressing only yoke 31 toward casing 90. Therefore, water leakage caused by this deformation is prevented.

### Fourth Embodiment

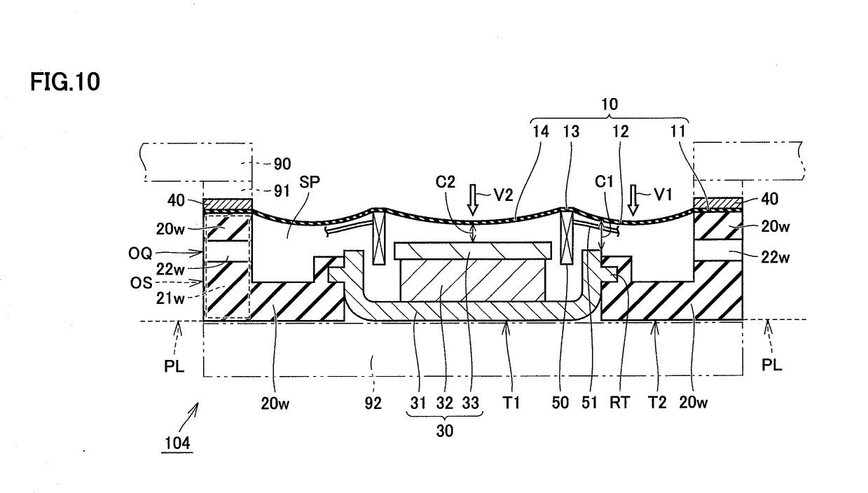

Referring to FIG. 10, a speaker 104 as an electroacoustic transducer of the present embodiment includes a frame 20w having a support portion 21w in place of frame 20 having support portion 21 (FIGS. 4 and 5). Frame 20w has a communicating path 22w that allows communication between space SP and the space external to frame 20w. Communicating path 22w has an opening OQ in outer side plane OS of support portion 21w. Opening OQ is located at a distance away from the upper plane of support portion 21w (the plane which supports edge 11) and also located at a distance away from fiat plane PL. In other words, communicating path 22w is a through hole provided in support portion 21w of frame 20w.

In addition, since the configurations other than those described above are almost the same as the configuration according to the above-described first embodiment, the same or corresponding components are designated by the same reference characters, and description thereof will not be repeated.

Although the speaker has been illustrated as an electroacoustic transducer in each of the above-described embodiments, the electroacoustic transducer should only have a diaphragm and a voice coil, and may be a receiver or a microphone, for example. Furthermore, although terms such as “upward direction”, “downward direction”, “upward”, and “downward” are used for convenience of explanation, these terms used herein are defined not in relation to the direction of gravitational force but in relation to the direction from the back plane to the front plane of the diaphragm. For example, the “upward direction” is defined as the direction extending from back plane to the front plane of the diaphragm, and the “downward direction” is defined as the direction extending from the front plane to the back plane of the diaphragm.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An electroacoustic transducer comprising:
a voice coil;
a diaphragm having a back plane which has said voice coil attached thereto and a front plane on a side opposite to said back plane, said diaphragm including a center portion, a boundary portion which surrounds said center portion and has said voice coil attached thereto, an outer circumferential portion which surrounds said boundary portion, and an edge which surrounds said outer circumferential portion; and
a frame having a support portion which supports said back plane of said diaphragm, said outer circumferential portion having a convex shape which protrudes, with respect to said edge, in a thickness direction from said front plane to said back plane.

2. The electroacoustic transducer according to claim 1, wherein said center portion has a convex shape protruding in said thickness direction with respect to said boundary portion.

3. The electroacoustic transducer according to claim 2, wherein said center portion has a flat portion as a portion most protruding in said thickness direction.

4. The electroacoustic transducer according to claim 1, further comprising a yoke which has a first bottom plane and applies a magnetic field to said voice coil, wherein
said frame has a second bottom plane which surrounds said first bottom plane, and
said first bottom plane and said second bottom plane are located flush with each other.

5. The electroacoustic transducer according to claim 1, further comprising a yoke which has a first bottom plane and applies a magnetic field to said voice coil, wherein
said frame has a second bottom plane which surrounds said first bottom plane, and
said second bottom plane protrudes in said thickness direction with respect to said first bottom plane.

6. The electroacoustic transducer according to claim 1, further comprising a magnetic circuit portion which applies a magnetic field to said voice coil, wherein
a clearance between said magnetic circuit portion and said outer circumferential portion is greater in said thickness direction than a clearance between said magnetic circuit portion and said center portion.

7. The electroacoustic transducer according to claim 1, wherein
said frame is located across space from said outer circumferential portion in said thickness direction and has a communicating path which allows communication between said space and space external to the frame, and
said communicating path has an opening in an outer side plane of said support portion.
